(19) United States
(12) Patent Application Publication
(10) Pub. No.: US 2017/0273345 A1
(43) Pub. Date: Sep. 28, 2017

(54) METHOD OF OPENING YOUNG COCONUT

(71) Applicant: FRANK HOANG, ANAHEIM, CA (US)

(72) Inventor: FRANK HOANG, ANAHEIM, CA (US)

(21) Appl. No.: 15/470,603

(22) Filed: Mar. 27, 2017

Related U.S. Application Data
(60) Provisional application No. 62/313,358, filed on Mar. 25, 2016.

(51) Int. Cl. A23N 5/03

(52) U.S. Cl. CPC A23N 5/03

(57) ABSTRACT

A method of opening a young coconut includes removing a top portion of a husk of the coconut to expose a top of a shell of the coconut, the top of the shell comprising a first vein, a second vein, and a third vein, etching a scoring into the top of the shell, the scoring passing through the first vein, the second vein, and the third vein, leveraging the shell at the scoring using a lever, and opening the coconut such that the shell cracks along the scoring

### RELATED APPLICATION

This application claims priority to provisional patent application U.S. Ser. No. 62/313,358 filed on Mar. 25, 2016, the entire contents of which is herein incorporated by reference.

### BACKGROUND

The present invention relates generally to coconuts and more particularly, to young coconuts.

Coconuts are nutritious and are becoming an increasingly popular source of water and food. Unfortunately, coconuts are also notoriously hard to open due to many layers of protection, including a hard green husk, a thick brown husk, and a hard shell. Currently available coconuts require much energy to open, and can involve potentially dangerous methods of opening.

Accordingly, there is a need for a safe, easy, and quick to open coconut that overcomes the shortcomings stated above.

### SUMMARY

The present invention aims to address the above by providing a safe, easy, and quick to open coconut and methods thereto.

An exemplary embodiment of a method of opening a young coconut comprises removing part of a husk to expose a top of a shell, the top of the shell comprising a first vein, a second vein, and a third vein of the coconut, applying a first pressure using a blunt object to the first vein, applying a second pressure using the blunt object to a first area between the first vein and the second vein, applying a third pressure using the blunt object to the second vein, and removing the shell to open the coconut.

In related versions, the method further comprises applying a fourth pressure using the blunt object to a second area between the second vein and third vein.

In related versions, the method further comprises applying pressure using the blunt object to the third vein.

In related versions, the method further comprises marking each vein with an “X” and each area between each vein with an “O”.

In related versions, removing the shell exposes a meat layer of the coconut.

In related versions, the method further comprises puncturing the meat layer.

In related versions, the applying pressure with the blunt object comprises striking the coconut.

An exemplary embodiment of a method of preparing a young coconut for opening comprises removing a top portion of a husk of the coconut to expose a top of a shell of the coconut to within a defined radius, the top of the shell comprising a first vein, a second vein, a third vein, and a vertex, the vertex being where the first vein, the second vein, and the third vein converge.

In related versions, the method further comprises shaping the husk into a pentagonal shape, the pentagonal shape comprising a pointy end and a flat end, prior to removing the top portion of the husk. The husk can also be shaped into a diamond or pentagon shape.

In related versions, the top portion of the husk comprises the pointy end.

In related versions, the method further comprises shrink-wrapping the coconut to retain freshness. The method can further comprise soaking the coconut in chemicals to prevent oxidizing and molding. For example, FDA-approved chemicals can be used.

In related versions, the method further comprises etching a scoring into the top of the shell to aid in opening the coconut. The scoring can be a pre-score that does not penetrate past the shell into a meat layer of the coconut. In this version, the coconut can be shaped such that the top half of the coconut shell is exposed, while the bottom half of the coconut remains covered by the husk (i.e., green husk or brown husk). The husk can further be shaped to taper downward such that the husk can fit into a cup holder.

In related versions, the method further comprises etching at least one notch into the scoring to aid in leveraging the shell to open the coconut. In other versions, at least three notches are etched into the scoring for safe and easy cracking open of the coconut.

In related versions, the scoring is circular and is centered on the vertex.

An exemplary embodiment of a method of opening a young coconut comprises securing the coconut, and removing a top portion of a husk of the coconut to expose a top of a shell of the coconut, the top of the shell comprising a first vein, a second vein, and a third vein, etching a scoring into the top of the shell, the scoring passing through the first vein, the second vein, and the third vein, leveraging the shell at the scoring using a lever, and opening the coconut such that the shell cracks along the scoring.

In related versions, the shell further comprises a vertex, the vertex being where the first vein, the second vein, and the third vein converge.

In related versions, the scoring is centered on the vertex.

In related versions, the scoring is circular in shape and within a defined radius.

In related versions, the scoring comprises at least one notched section, the at least one notched section for aid in leveraging the shell. The notch can be an extension of the scoring. In other versions, the scoring comprises at least three notched sections. This allows safe and easy cracking open of the coconut with a single try. For example, a lever such as a butter knife can be inserted into the notch, tapped into the coconut to penetrate the remainder of the shell under the notch, and used as leverage to pop open the coconut along the scoring.

In related versions, the method further comprises securing the lever into the shell prior to leveraging the shell for opening.

The contents of this summary section are provided only as a simplified introduction to the invention, and are not intended to be used to limit the scope of the appended claims. The present disclosure has been described above in terms of presently preferred embodiments so that an understanding of the present disclosure can be conveyed. However, there are other embodiments not specifically described herein for which the present disclosure is applicable. Therefore, the present disclosure should not be seen as limited to the forms shown, which should be considered illustrative rather than restrictive.

### BRIEF DESCRIPTION OF THE FIGURES

The detailed description of some embodiments of the invention is made below with reference to the accompanying figures, wherein like numerals represent corresponding parts of the figures.

FIG. 1 is a perspective diagram of a young coconut according to related versions.

FIG. 2 is a top view of the young coconut of FIG. 1.

FIG. 3A is a top view of an alternative version of the young coconut of FIG. 1.

FIG. 3B is a top view of an alternative version of the young coconut of FIG. 1.

FIG. 3C is a top view of an alternative version of the young coconut of FIG. 1.

FIG. 4 is a perspective view of a young coconut with a scoring according to related versions.

FIG. 5 is a top view of the young coconut of FIG. 4.

FIG. 6 is a top view of an alternative version of the young coconut of FIG. 4.

FIG. 7 is a flow diagram of a method of opening the young coconut of FIG. 1 according to related versions.

FIG. 8 is a flow diagram of a method of preparing a young coconut for opening according to related versions.

FIG. 9 is a flow diagram of a method of opening the young coconut of FIG. 4 according to related versions.

### DETAILED DESCRIPTION OF CERTAIN EMBODIMENTS

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

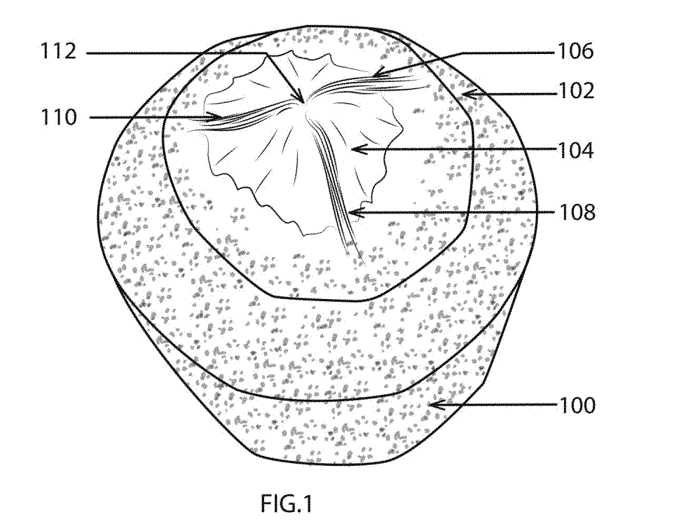

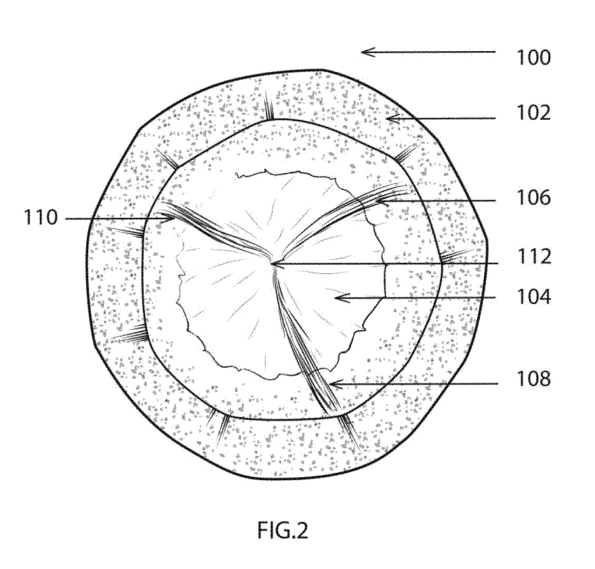

Referring to FIGS. 1 and 2, young coconut 100 according to related versions is illustrated. Young coconut 100 can comprise husk 102 (i.e., green husk or brown husk), shell 104, first vein 106, second vein 108, third vein 110, and vertex 112.

Husk 102 can be substantially pentagonal in shape, and can be trimmed to reveal top 114 of shell 104. For example, husk 102 can initially be trimmed according to known methods to form a diamond or pentagon shape, with a pointy end (i.e., top) and a flat end (i.e., bottom). The pointy end can be shaved off to expose top 114 of shell 104 such that the top of husk 402 is substantially flat.

In related versions, top 114 of shell 104 is revealed to within a defined radius. For example, the defined radius cannot be larger than half the radius of the coconut. This is to prevent too much of shell 104 from becoming exposed. Only top 114 needs to be exposed in order to allow for easy opening of young coconut 100. In some versions the defined radius is 1″, for a total of a 2″ diameter. This would allow for a common kitchen object, such as a soup spoon, to penetrate into shell 104 to remove the coconut meat once top 114 of shell 104 has been removed and the coconut water has been consumed.

Husk 102 is not completely removed to preserve freshness of young coconut 100. Husk 102 only needs to be removed to expose just enough shell 104 to allow for easy opening as described herein.

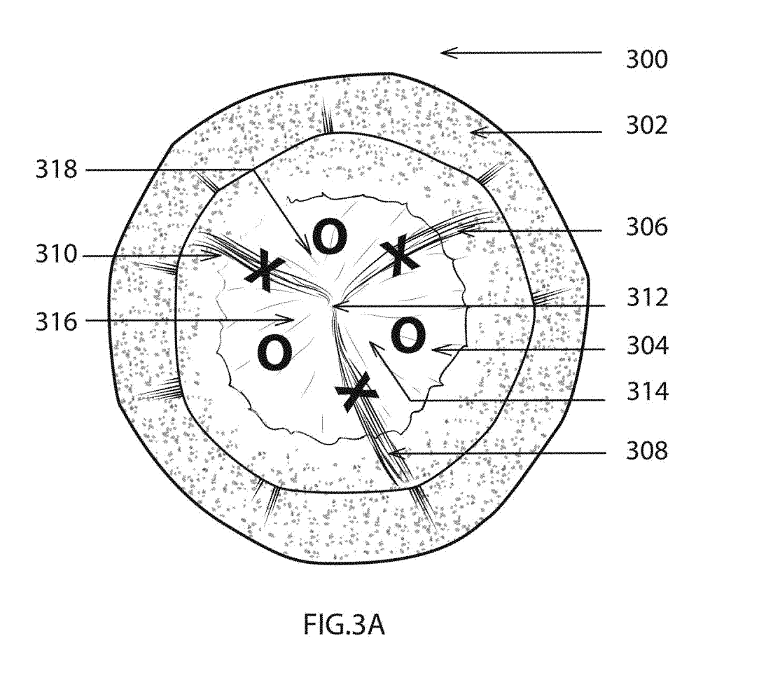

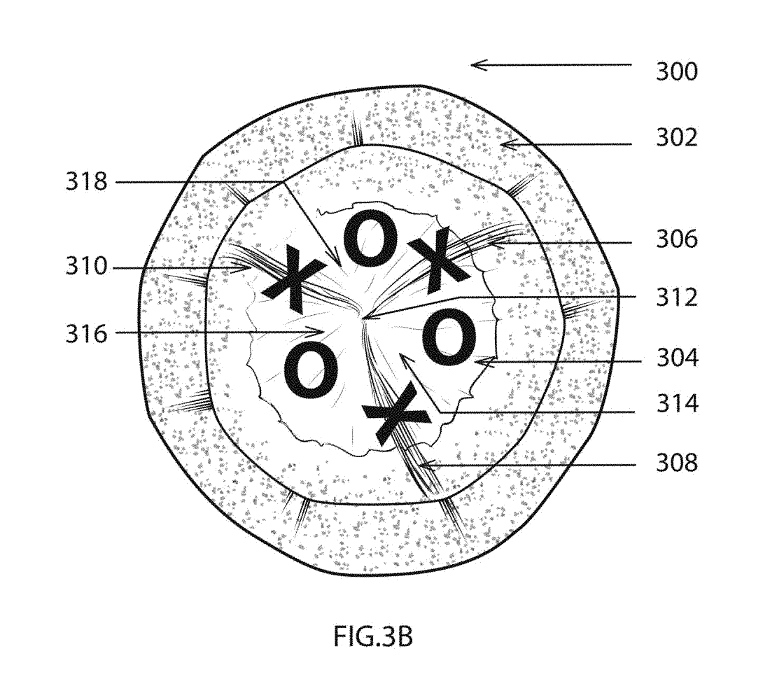

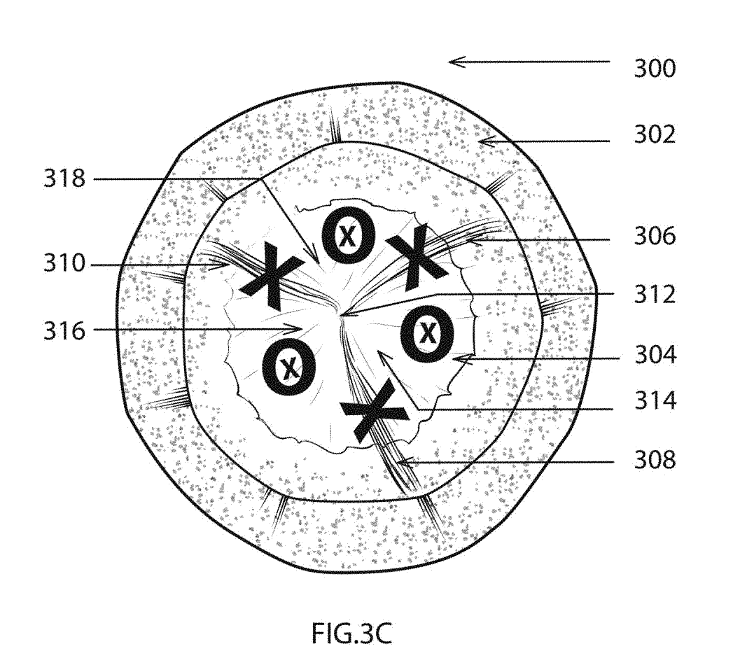

Referring to FIG. 3A, an alternative young coconut 300 according to related versions is illustrated. Young coconut 300 can comprise husk 302, shell 304, first vein 306, second vein 308, third vein 310, and vertex 312. As depicted, each vein 306, 308, 310 can be marked with an “X”, or any other type of marking known in the art. For example, the marking can be printed on, drawn on, glued on, engraved on, or otherwise imprinted onto shell 304.

In related versions, an “O” can be marked in areas 314, 316, 318, which are located between veins 306, 308, 310. For example, the marking can be printed on, drawn on, glued on, engraved on, or otherwise imprinted onto shell 304.

In related versions, the “X” and “O” markings can be in various shapes, sizes, and fonts. For example, the “X” markings can be generally larger than the “O” markings, or the “O” markings can be generally larger than the “X” markings (FIG. 3B). Alternatively, all of the markings can be of various sizes in relation to each other. In related versions the “O” markings can be sized to substantially fill up areas 314, 316, 318.

In another version, the markings can comprise an “O” with an “X” inside of the “O”, as depicted in FIG. 3C.

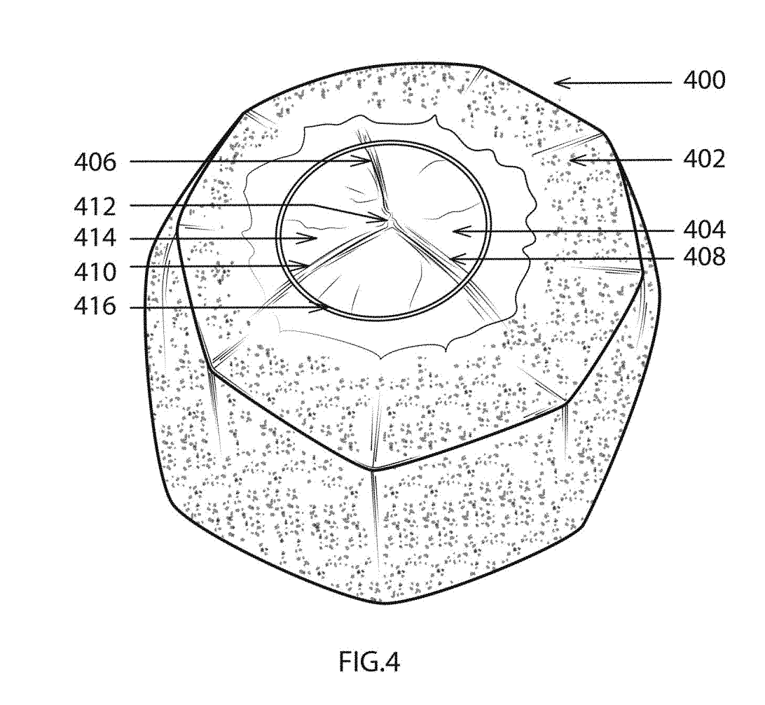

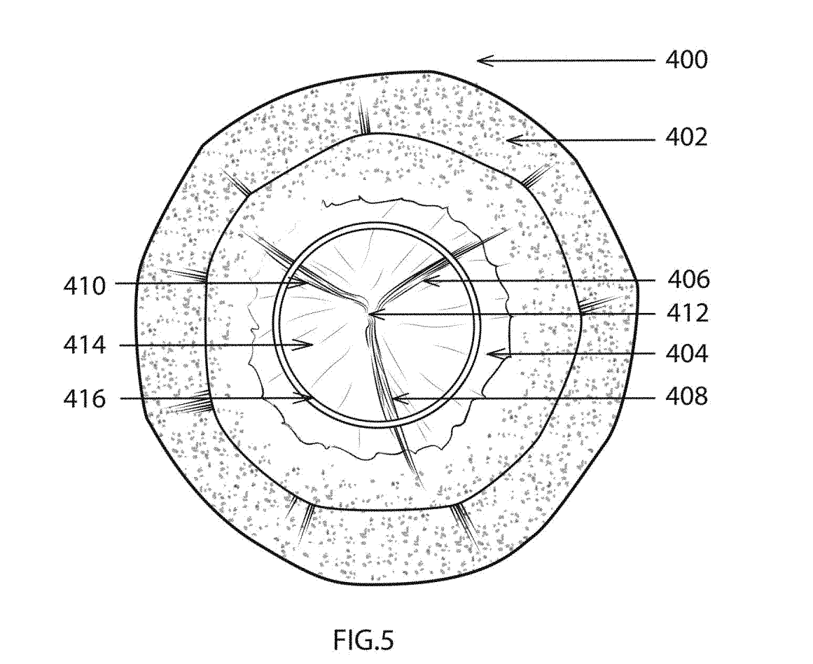

Referring to FIGS. 4 and 5, young coconut 400 according to related versions is illustrated. Young coconut 400 can comprise husk 402, shell 404, first vein 406, second vein 408, third vein 410, and vertex 412.

Husk 402 can be substantially pentagonal in shape, and can be trimmed to reveal top 414 of shell 404. For example, husk 402 can initially be trimmed according to known methods to form a diamond or pentagon shape, with a pointy end (i.e., top) and a flat end (i.e., bottom). The pointy end can be shaved off to expose top 414 of shell 404 such that the top of husk 402 is substantially flat.

In related versions, top 414 of shell 404 is revealed to within a defined radius. For example, the defined radius cannot be larger than half the radius of the coconut. This is to prevent too much of shell 404 from becoming exposed. Only top 414 needs to be exposed in order to allow for easy opening of young coconut 400. In some versions, the defined radius is about 1.5″.

Scoring 416 can be etched into shell 404 according to methods well-known in the art. For example, scoring 416 can be carved, engraved, or otherwise scored into shell 404 to create a weakened portion in shell 404 for easy opening. Scoring 416 can be any shape, including, but not limited to, square, circle, triangle, pentagon, hexagon, etc. In related versions, scoring 416 can be centered on vertex 412. Additionally, scoring 416 can have a defined scoring radius that is less than the defined radius of top 414. Scoring 416 can be only on shell 404, not extending onto husk 402. In some versions, the scoring radius is about 1″.

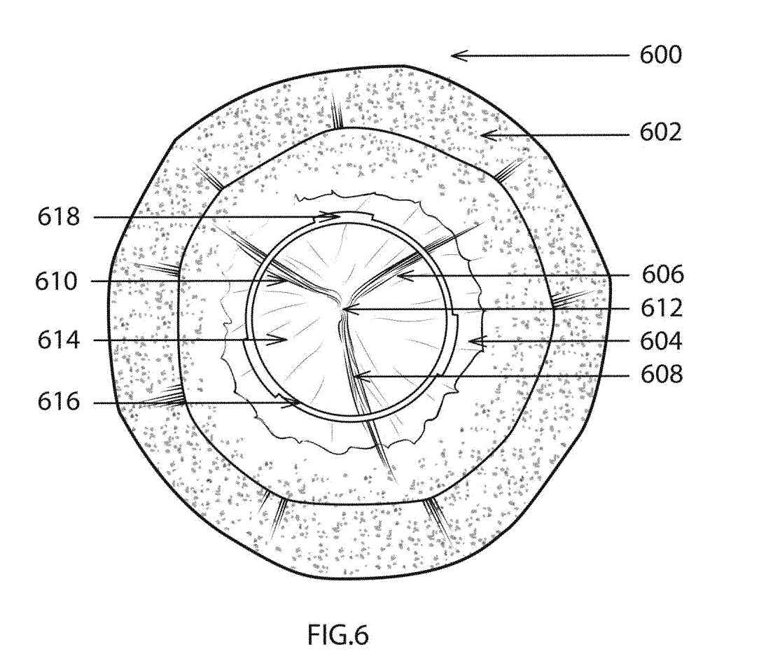

Referring to FIG. 6, an alternative young coconut 600 according to related versions is illustrated. Young coconut 600 can comprise husk 602, shell 604, first vein 606, second vein 608, third vein 610, and vertex 612.

Husk 602 can be substantially pentagonal in shape, and can be trimmed to reveal top 614 of shell 604. For example, husk 602 can initially be trimmed according to known methods to form a diamond or pentagon shape, with a pointy end (i.e., top) and a flat end (i.e., bottom). The pointy end can be shaved off to expose top 614 of shell 604 such that the top of husk 602 is substantially flat.

In some versions, the coconut 600 can be shaped such that the top half 601 of the coconut shell 604 is exposed, and/or the bottom half 603 of the coconut remains covered by the husk (i.e., green husk or brown husk). The husk 602 can further be shaped to taper downward such that the husk 604 can fit into a cup holder. This allows for easy transportation of the coconut 600 in a motor vehicle, and also allows for easy placement. The tapered husk as described herein can be implemented into any of the described versions of the young coconuts herein. For example, the tapered husk can be implemented into any of the coconuts of FIGS. 1-5, according to the descriptions herein.

In related versions, top 614 of shell 604 is revealed to within a defined radius. For example, the defined radius cannot be larger than half the radius of the coconut. This is to prevent too much of shell 604 from becoming exposed. Only top 614 needs to be exposed in order to allow for easy opening of young coconut 600.

Scoring 616 can be etched into shell 604 according to methods well-known in the art. For example, scoring 616 can be carved, engraved, or otherwise scored into shell 604 to create a weakened portion in shell 604 for easy opening. Scoring 616 can be any shape, including, but not limited to, square, circle, triangle, pentagon, hexagon, etc. In related versions, scoring 616 can be centered on vertex 612 and can extend through veins 606, 608, 610. Additionally, scoring 616 can have a defined scoring radius that is less than the defined radius of top 614. Scoring 616 can be only on shell 604, not extending onto husk 602.

In related versions, scoring 616 can comprise at least one notch 618 for aiding leverage in opening young coconut 600. For example, notch 618 can be located on scoring 616 between first vein 606 and second vein 608. In related versions, scoring 616 can comprise three notches 618, 620, 622, each notch located in an area 624, 626, 628 defined between veins, as illustrated. Notches 618, 620, 622 can be etched onto scoring 616 according to methods well-known in the art. For example, notches 618, 620, 622 can be carved, engraved, or otherwise scored into shell 604 to create a weakened portion in shell 604 for easy leveraging of shell 604. Notches 618, 620, 622 can be any shape, including, but not limited to, rectangular, square, circular, ovular, etc. Notches 618, 620, 622 can be evenly spaced and located at midpoints of areas 624, 626, 628 between veins 606, 608, 610.

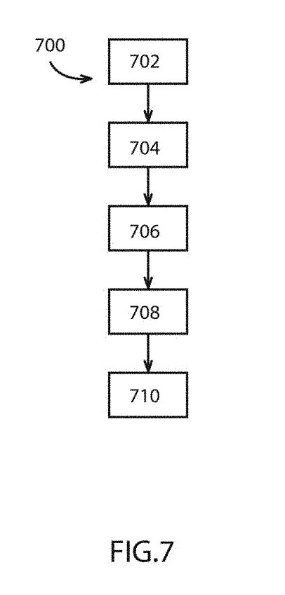

Referring to FIG. 7, aspects of a method 700 of opening a young coconut is illustrated. The method 700 may include, for example, at 702, removing part of a husk to expose a top of a shell, the top of the shell comprising a first vein, a second vein, and a third vein of the coconut.

In related versions, the husk is first formed into a diamond or pentagon shape, with a pointy end (i.e., top end) and a flat end (i.e., bottom end). The pointy end is then cut off to form a substantially flat top with a slight curvature representing the exposed top of the shell.

In related versions, the flat end of the husk can be shaped at a substantial angle to allow the coconut to rest at an angle without tipping over. This is advantageous for allowing easier access to drinking the coconut water from the coconut.

At 704, pressure is applied using a blunt object to the first vein. For example, the blunt object can be any ordinary object found in a kitchen, such as a knife, spoon, and/or fork, or other related items. In related versions, applying pressure with the blunt object comprises striking the coconut with the blunt object. For example, the pressure can comprise a firm knock against the coconut.

At 706, pressure is applied using the blunt object to an area between the first vein and the second vein.

At 708, pressure is applied using the blunt object to the second vein. As can be seen, pressure is applied in a circular manner around the shell at discrete points to create an even crack in the shell for safe, easy, and fast opening.

In related versions, the method further comprises marking each vein with an “X” and each area between each vein with an “O”. According to the description herein, alternative markings can be used as well in lieu of “X” and “O”. In related versions, the markings indicate consecutive striking points (i.e., points at which to apply pressure) on the shell. The purpose of the markings is to provide indications of where to apply pressure to the coconut, and in what order. For example, in the case of using “X” and “O”, the coconut is struck at “X” first, then “O”, then “X” again. Alternative markings can be used that would indicate the locations and the order of applying pressure.

In related versions, the “X” and “O” markings can be in various shapes, sizes, and fonts. For example, the “X” markings can be generally larger than the “O” markings, or the “O” markings can be generally larger than the “X” markings. Alternatively, all of the markings can be of various sizes in relation to each other. In related versions the “O” markings can be sized to substantially fill up the areas between the veins.

In another version, the markings can comprise an “O” with an “X” inside of the “O”, as depicted in FIG. 3B.

At 710, the top of the shell is removed to open the coconut. In some versions, the top of the shell is not completely removed from the coconut, but instead remains connected so as to function as a lid. As can be seen, the coconut is opened safely, easily, and quickly.

In related versions, the method further comprises applying pressure using the blunt object to an area between the second vein and third vein.

In related versions, the method further comprises applying pressure using the blunt object to the third vein.

In related versions, removing the shell exposes a meat layer of the coconut. As is well known, every coconut comprises a meat layer, underneath which is the coconut water. Exposing only the meat allows puncturing of the meat layer with an object, such as a drinking straw, or the like, to access the coconut water. At the same time, because no other portion of the meat layer is punctured, a seal for the drinking straw can be formed to prevent spillage.

Once all of the coconut water has been consumed, the meat layer can be harvested for eating or other uses, such as for cooking, making coconut milk, coconut oil, coconut butter, or smoothies.

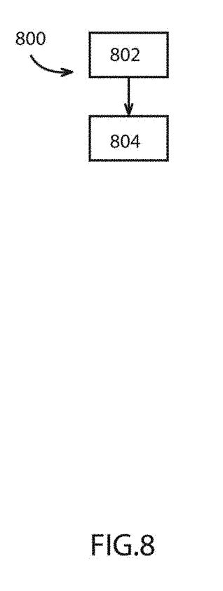

Referring to FIG. 8, aspects of a method 800 of preparing a young coconut for opening is illustrated. The method 800 may include, for example, at 802, the coconut is secured.

At 804, a top portion of a husk of the coconut is removed to expose a top of a shell of the coconut to within a defined radius, the top of the shell comprising a first vein, a second vein, a third vein, and a vertex, the vertex being where the first vein, the second vein, and the third vein converge. For example, the defined radius of the exposed top shell can be about half of the radius of the coconut. In some versions, the defined radius of the exposed top shell is about 1.5″.

In related versions, the husk is first formed into a diamond or pentagon shape, with a pointy end (i.e., top end) and a flat end (i.e., bottom end). The pointy end is then cut off to form a substantially flat top with a slight curvature representing the exposed top of the shell.

In related versions, the flat end of the husk can be shaped at a substantial angle to allow the coconut to rest at an angle without tipping over. This is advantageous for allowing easier access to drinking the coconut water from the coconut.

In related versions, the method further comprises shaping the husk into a pentagonal shape, the pentagonal shape comprising a pointy end and a flat end.

In related versions, the top portion of the husk comprises the pointy end.

In related versions, the method further comprises shrink-wrapping the coconut to retain freshness. The method can further comprise soaking the coconut in chemicals to prevent oxidizing and molding. For example, FDA-approved chemicals can be used. The shrink-wrapping can be standard shrink wrap as well-known in the art.

In related versions, the method further comprises etching a scoring into the top of the shell to aid in opening the coconut.

In related versions, the method further comprises etching at least one notch into the scoring to aid in leveraging the shell to open the coconut.

In related versions, the scoring is circular and is centered on the vertex.

In related versions, the method further comprises marking each vein with an “X” and each area between each vein with an “O”. According to the description herein, alternative markings can be used as well in lieu of “X” and “O”. In related versions, the markings indicate consecutive striking points (i.e., points at which to apply pressure) on the shell. The purpose of the markings is to provide indications of where to apply pressure to the coconut in order to get it open, and in what order. For example, in the case of using “X” and “O”, the coconut is struck at “X” first, then “O”, then “X” again. Alternative markings can be used that would indicate the locations and the order of applying pressure.

In related versions, the “X” and “O” markings can be in various shapes, sizes, and fonts. For example, the “X” markings can be generally larger than the “O” markings, or the “O” markings can be generally larger than the “X” markings. Alternatively, all of the markings can be of various sizes in relation to each other. In related versions the “O” markings can be sized to substantially fill up the areas between the veins.

In another version, the markings can comprise an “O” with an “X” inside of the “O”, as depicted in FIG. 3B.

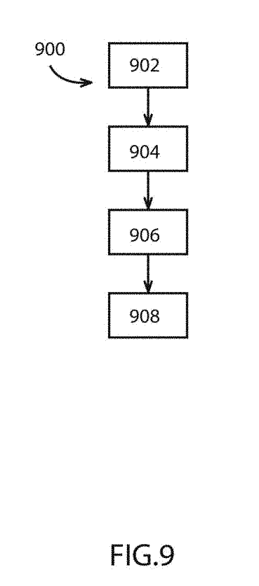

Referring to FIG. 9, aspects of a method 900 of opening a young coconut is illustrated. The method 900 may include, for example, at 902, removing a top portion of a husk of the coconut to expose a top of a shell of the coconut, the top of the shell comprising a first vein, a second vein, and a third vein.

In related versions, the husk is first formed into a diamond or pentagon shape, with a pointy end (i.e., top end) and a flat end (i.e., bottom end). The pointy end is then cut off to form a substantially flat top with a slight curvature representing the exposed top of the shell.

In related versions, the flat end of the husk can be shaped at a substantial angle to allow the coconut to rest at an angle without tipping over. This is advantageous for allowing easier access to drinking the coconut water from the coconut.

At 904, a scoring is etched into the top of the shell, the scoring passing through the first vein, the second vein, and the third vein.

At 906, the shell is leveraged at the scoring using a lever. The lever can be any standard tool found in the kitchen, including, but not limited to, a spoon, fork, and/or knife.

At 908, the coconut is opened such that the shell cracks along the scoring.

In related versions, the shell further comprises a vertex, the vertex being where the first vein, the second vein, and the third vein converge.

In related versions, the scoring is centered on the vertex.

In related versions, the scoring is circular in shape and within a defined radius. For example, the defined radius can be less than half of the radius of the coconut. In related versions, the scoring has a radius of around 1″.

In related versions, the scoring comprises at least one notched section, the at least one notched section for aid in leveraging the shell. For example, the notched section can be various shapes, including, but not limited to, rectangular, square, rounded, ovular, etc.

In related versions, the method further comprises securing the lever into the shell prior to leveraging the shell for opening. For example, the lever can be thrust into the shell, pounded into the shell, and/or hammered into the shell. Alternatively, the lever can be placed at the scoring, and the entire coconut is picked up from its support (i.e., table, or other stable surface, etc.) and firmly placed back down, causing the lever to become secured into the shell. Afterwards, the lever can easily open the coconut.

The previous description of the disclosed aspects is provided to enable any person skilled in the art to make or use the present disclosure. Various modifications to these aspects will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The specification and drawings are, accordingly, to be regarded in an illustrative rather than a restrictive sense. It will, however, be evident that various modifications, combinations, and changes may be made thereunto without departing from the broader spirit and scope of the disclosure as set forth in the claims.

The description of the subject technology is provided to enable any person skilled in the art to practice the various embodiments described herein. While the subject technology has been particularly described with reference to the various figures and embodiments, it should be understood that these are for illustration purposes only and should not be taken as limiting the scope of the subject technology.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various embodiments described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

As used in this application, the term “a” or “an” means “at least one” or “one or more.”

As used in this application, the term “about” or “approximately” refers to a range of values within plus or minus 10% of the specified number.

As used in this application, the term “substantially” means that the actual value is within about 10% of the actual desired value, particularly within about 5% of the actual desired value and especially within about 1% of the actual desired value of any variable, element or limit set forth herein.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Any element in a claim that does not explicitly state “means for” performing a specified function, or “step for” performing a specified function, is not to be interpreted as a “means” or “step” clause as specified in 35 U.S.C. §112, ¶ 6. In particular, any use of “step of” in the claims is not intended to invoke the provision of 35 U.S.C. §112, ¶ 6.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A method of opening a young coconut comprising:
removing part of a husk to expose a top of a shell, the top of the shell comprising a first vein, a second vein, and a third vein of the young coconut;
applying a first pressure using a blunt object to the first vein;
applying a second pressure using the blunt object to a first area between the first vein and the second vein;
applying a third pressure using the blunt object to the second vein; and
removing the shell to open the young coconut.

2. The method of claim 1 further comprising applying a fourth pressure using the blunt object to a second area between the second vein and the third vein.

3. The method of claim 2 further comprising applying pressure using the blunt object to the third vein.

4. The method of claim 3 further comprising marking each vein with an “X” and the first area and the second area with an “O”.

5. The method of claim 1 wherein removing the shell exposes a meat layer of the young coconut.

6. The method of claim 5 further comprising puncturing the meat layer.

7. The method of claim 1 wherein the applying pressure with the blunt object comprises striking the young coconut.

8. A method of preparing a young coconut for opening comprising:
securing the young coconut; and
removing a top portion of a husk of the young coconut to expose a top of a shell of the young coconut to within a defined radius, the top of the shell comprising a first vein, a second vein, a third vein, and a vertex, the vertex being where the first vein, the second vein, and the third vein converge.

9. The method of claim 8 further comprising shaping the husk into a pentagonal shape, the pentagonal shape comprising a pointy end and a flat end.

10. The method of claim 9 wherein the top portion of the husk comprises the pointy end.

11. The method of claim 8 further comprising shrink-wrapping the young coconut to retain freshness.

12. The method of claim 8 further comprising etching a scoring into the top of the shell to aid in opening the young coconut.

13. The method of claim 12 further comprising etching at least one notch into the scoring to aid in leveraging the shell to open the young coconut.

14. The method of claim 12 wherein the scoring is circular and is centered on the vertex.

15. A method of opening a young coconut comprising:
removing a top portion of a husk of the young coconut to expose a top of a shell of the young coconut, the top of the shell comprising a first vein, a second vein, and a third vein;
etching a scoring into the top of the shell, the scoring passing through the first vein, the second vein, and the third vein;
leveraging the shell at the scoring using a lever; and
opening the young coconut such that the shell cracks along the scoring.

16. The method of claim 15 wherein the shell further comprises a vertex, the vertex being where the first vein, the second vein, and the third vein converge.

17. The method of claim 16 wherein the scoring is centered on the vertex.

18. The method of claim 15 wherein the scoring is circular in shape and within a defined radius.

19. The method of claim 15 wherein the scoring comprises at least one notched section, the at least one notched section for aid in leveraging the shell.

20. The method of claim 15 further comprising securing the lever into the shell prior to leveraging the shell for opening.
